(19) United States
(12) Patent Application Publication
(10) Pub. No.: US 2014/0310634 A1
(43) Pub. Date: Oct. 16, 2014

(54) DYNAMIC FLUID BEHAVIOR DISPLAY SYSTEM

(71) Applicant: Schlumberger Technology Corporation, Sugar Land, TX (US)

(72) Inventors: Samuel Glynn McLellan, Temple, TX (US); Bobby Kiehn, Houston, TX (US); Philippe Steinthal, Houston, TX (US)

(73) Assignee: Schlumberger Technology Corporation, Sugar Land, TX (US)

(21) Appl. No.: 14/247,429

(22) Filed: Apr. 8, 2014

Related U.S. Application Data
(60) Provisional application No. 61/811,337, filed on Apr. 12, 2013.

(51) Int. Cl. G06F 3/0484

(52) U.S. Cl. CPC G06F 3/04847
USPC 715/771

(57) ABSTRACT

A method, apparatus, and program product implement a graphical user interface that includes a production display and a properties display corresponding to an oil and gas production system. The production display includes a simulated model corresponding to the oil and gas production system, and the properties display includes fluid properties corresponding to the oil and gas production system. User input may be received and the graphical user interface dynamically updates the production display or properties display based thereon, such that the fluid properties of the oil and gas production system may be dynamically modeled with the graphical user interface.

### CROSS-REFERENCE TO RELATED APPLICATION

This application claims the benefit of U.S. Provisional Application No. 61/811,337 filed on Apr. 12, 2013 by Sam McLellan et al., the entire disclosure of which is incorporated by reference herein in its entirety.

### BACKGROUND

In the oil and gas industry, many production operation hazards are associated with the transportation of fluids through a system of flow lines and equipment. When oil, gas, and water simultaneously flow in a well or pipeline, problems related to flow instability, erosion, corrosion, and solids formation may lead to risk of blockages or other complications. For design of an oil and gas production system, one or more software applications may use tools such as logical network diagrams to design, model, analyze, and optimize an oil and gas production system in part or completely, e.g., the flow in a pipelines and facilities surface system, the performance of a system of production and injection wells, or a network of multiple wells or sources. These logical networks may incorporate multiple building blocks of node and connection type objects (e.g., wells, compressors, pump, separators, etc.), which an oil and gas specialist may assemble together in order to logically and visually represent on a two-dimensional canvas the different equipment and their properties that make up a specific, often complex model of the oil and gas production system, and that may be used to simulate, analyze, understand, and optimize the behavior of the system or the impact of alternative designs. During design of such a system, design professionals strive to ensure that produced fluids are economically and safely transported through flow lines and equipment to processing facilities of the on and gas system. The safe and economical design of an oil and gas system presents unique challenges since a plurality of factors related to the produced fluids, equipment, flow lines, or processing facilities may affect the safety and economy of a design.

To aid in the design, fluid properties and behaviors may be considered for an oil and gas production system, and a substantial need continues to exist in the art for an improved system and apparatus to assist in modeling fluid properties and behaviors for a system design.

### SUMMARY

The embodiments disclosed herein provide a method, apparatus, and program product that dynamically model fluid properties for an oil and gas production system. Consistent with embodiments of the invention, a graphical user interface may include a production display and a properties display. The production display may include a simulated model of the oil and gas production system, and the properties display may include one or more fluid properties that correspond to the oil and gas, production system of the production display. In these embodiments of the invention, the displays of the graphical user interface may dynamically update based on user input. Therefore, embodiments of the invention may provide oil and gas flow assurance specialists with a dynamic user interface with which to model/illustrate the effects of fluid composition, fluid characterization or reservoir, wellbore or pipeline condition changes dynamically in an oil and gas production system.

Consistent with some embodiments of the invention, an oil and gas production system may be visualized (e.g., as a simulated model corresponding to the oil and gas production system) in a production display of a graphical user interface using a processor, and fluid properties corresponding to the oil and gas production system may be visualized in a properties display of the graphic user interface using the processor. In general, user input may cause the processor to update at least one of the displays based on the user input. For example, user input may select one or more objects of the oil and gas production system in the production display, and the properties display may be updated to display fluid properties corresponding to the one or more selected objects. Similarly, user input may select a fluid property parameter in the properties display, and the production display may be updated to visually identify in the simulated model one or more objects of the oil and gas production system that correspond to the selected fluid property parameter. In general, the displays of the graphical user interface may be updated based at least in part on user input. The displays may be updated in response to user input.

Furthermore, some embodiments of the invention may dynamically determine the corresponding objects/fluid properties corresponding to the selected objects/fluid property parameter of the user input. For example, the processor may perform one or more calculations associated with a selected object to determine fluid properties associated with the selected object. Likewise, the processor may analyze objects of the oil and gas production system to determine objects corresponding to the input fluid property parameter. In addition, the processor may determine additional fluid properties that correspond to a selected fluid property parameter.

Therefore, consistent with one aspect of the invention, the method for dynamically modeling fluid behavior for an oil and gas production system includes receiving user input data directed to a graphical user interface that includes a production display including a simulated model representative of the oil and gas production system and a properties display including fluid properties corresponding to the oil and gas production system, and in response to receiving user input data directed to the properties display that selects a fluid property parameter, updating, with at least one processor, the production display to correspond to the selected fluid property parameter.

Consistent with another aspect of the invention, a system includes at least one processor and program code configured upon execution by the processor to dynamically model fluid properties for an oil and gas production system by receiving user input data directed to a graphical user interface that includes a production display including a simulated model representative of the oil and gas production system and a properties display including fluid properties corresponding to the oil and gas production system, and in response to receiving user input data directed to the properties display that selects a fluid property parameter, updating, with the processor, the production display to correspond to the selected fluid property parameter.

Consistent with yet another aspect of the invention, a computer program product includes a computer readable medium, and program code resident on the computer readable medium and configured upon execution by a processor to dynamically model fluid properties for an oil and gas production system by receiving user input data directed to a graphical user interface that includes a production display including a simulated model representative of the oil and gas production system and a properties display including fluid properties corresponding to the oil and gas production system, and in response to receiving user input data directed to the properties display that selects a fluid property parameter, updating, with the processor, the production display to correspond to the selected fluid property parameter.

Some embodiments, in response to receiving user input data directed to the production display that selects an object of the simulated model, update the properties display to include fluid properties associated with the selected object. Also, some embodiments, in response to receiving user input data directed to the production display that selects an object of the simulated model, calculate a fluid phase envelope plot for the selected object. In such embodiments updating the display to include fluid properties associated with the selected object may involve updating the display to include the fluid phase envelope plot. In addition, some embodiments dynamically determine a flash task calculation for a fluid at predefined operating conditions associated with the selected object in response to receiving user input data directed to the production display that selects an object of the simulated model.

In some embodiments, the properties display includes a phase envelope plot of a fluid associated with the oil and gas production system. Further, in some embodiments, the user input selects a fluid property parameter on the phase envelope plot, and updating the production display includes updating the production display to identify at least one object of the oil and gas production system that corresponds to the fluid property parameter. Some embodiments also, in response to receiving user input data directed to the properties display that selects a fluid property parameter, update the properties display with additional fluid properties associated with the selected fluid property parameter. In addition, some embodiments analyze objects of the oil and gas production system to identify objects corresponding to the selected fluid property parameter. In such embodiments, updating the production display to correspond to the selected fluid property parameter may include indicating the identified object corresponding to the selected fluid property parameter in the simulated model of the production display.

Further, in some embodiments, the properties display includes a fluid phase envelope plot, and the selected fluid property parameter corresponds to a region of the fluid phase envelope. In addition, such embodiment may analyze objects of the oil and gas production system to identify each object that corresponds to the region of the fluid phase envelope. In such an embodiment, updating the production display to correspond to the selected fluid property parameter may involve updating the production display to include an indication for each identified object.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIG. 1 is a block diagram of an example hardware and software environment for a data processing system in accordance with implementation of various technologies and techniques described herein.

FIGS. 2A-2D illustrate simplified, schematic views of an oilfield having subterranean formations containing reservoirs therein in accordance with implementations of various technologies and techniques described herein.

FIG. 3 illustrates a schematic view, partially in cross section of an oilfield having a plurality of data acquisition tools positioned at various locations along the oilfield for collecting data from the subterranean formations in accordance with implementations of various technologies and techniques described herein.

FIG. 4 illustrates a production system for performing one or more oilfield operations in accordance with implementations of various technologies and techniques described herein.

FIG. 5 provides a flowchart that illustrates a sequence of operations that may be performed by the data processing system of FIG. 1 consistent with embodiments of the invention.

FIG. 6 is a display representation of a graphical user interface that may be output by the data processing system of FIG. 1 to dynamically model fluid properties of an oil and gas production system.

FIG. 7 is the display representation of the graphical user interface of FIG. 6 that includes a phase envelope plot.

FIG. 8 is a display representation of a graphical user interface that may be output by the data processing system of FIG. 1 to dynamically model fluid properties of an oil and gas production system.

### DETAILED DESCRIPTION

The herein-described embodiments invention provide a method, apparatus, and program product for dynamically updating display of a simulated model corresponding to an oil and gas production system and one or more fluid properties associated with the oil and gas production system in a graphical user interface. More specifically, a graphical user interface may provide a production display that provides a simulated model corresponding to the oil and gas production system and a properties display that provides fluid properties associated with the oil and gas production system. The production display or the properties display may be dynamically updated based on user input. The user input may select one or more objects of the oil and gas production system on the simulated model of the production display or select a fluid property parameter on the properties display. Dynamically updating the production display or the properties display may include determining one or more fluid properties corresponding to a selected fluid property parameter or determining one or more objects of the oil and gas system corresponding to the selected fluid property parameter and updating the displays based on such determined fluid properties or objects.

Consistent with embodiments of the invention, the production display may include a logical network diagram corresponding to an oil and gas production system, a Geographic Information System (GIS) map, or other known types of models that may be utilized in the design or monitoring of oil and gas production systems. The properties display may include various types of fluid properties corresponding to the oil and gas production system (e.g., flow rate, components of a fluid, proportion of the components, temperature, pressure, proportions of phases (water, hydrocarbon liquid, vapor) by mass, mole, and volume, molecular weight, density, molar density, enthalpy, entropy, internal energy, Gibbs free energy, isochoric heat capacity, thermal conductivity, speed of sound, joule-thomson coefficient, and Z-factor or other properties not listed) that may be presented in various formats, such as charts, graphs, text, images, or other such formats that may be utilized to express fluid properties for oil and gas production systems.

For example, if user input selects a particular fluid as the selected fluid property parameter the processor may dynamically update the graphical user interface to display the selected fluid's phase proportions (e.g., gas/oil ratio, water cut, etc.), individual components (e.g., aqueous or hydrocarbon elements) or proportions (e.g., moles, mole fractions, etc.) within each phase (e.g., vapor, liquid, or water), or whether the selected fluid is currently being used in the oil and gas production system or not. As another example, if user input selects an object, the processor may dynamically update the graphical user interface to display fluid flow characteristics for the object or a branch of the oil and gas production system corresponding to the selected object. Furthermore, the processor may perform a fluid flash calculation for a selected fluid and display the selected fluid's behavior at standard or user defined conditions for the oil and gas production system (e.g., a single click on a display may calculate for pressure and temperature). In addition, the processor may calculate fluid phase envelopes for a selected object and dynamically update the graphical user interface to display the calculated fluid phase envelope for the selected object, where a fluid phase diagram or envelope is a graph that illustrates the relation between the solid, liquid, and gaseous states of a substance as a function of the temperature and pressure.

As another example, the processor may calculate a fluid tuning calculation for a selected fluid's behavior with user-specified overrides to fluid properties, and the processor may dynamically update the graphical user interface to display the fluid tuning calculation for the selected fluid. Moreover, embodiments of the invention may facilitate network-to-phase envelope mapping, such that a selected fluid phase parameter may be selected on a phase envelope provided in the properties display, and one or more objects of the oil and gas system (i.e., the network) may be identified that correspond to the selected fluid phase parameter. Consistent with these embodiments of the invention, selection of a fluid property parameter on the properties display may select objects in the production display corresponding to the fluid property parameter. In general, a fluid property parameter may be a pressure and temperature that define a point on a phase envelope or a range of temperatures and pressures that define a region on a phase envelope.

The above provided examples illustrate the dynamic updating and display of the displays of the graphical user interface consistent with embodiments of the invention; however, the invention is not limited to only the provided examples. Other variations and modifications will be apparent to one of ordinary skill in the art.

### Hardware and Software Environment

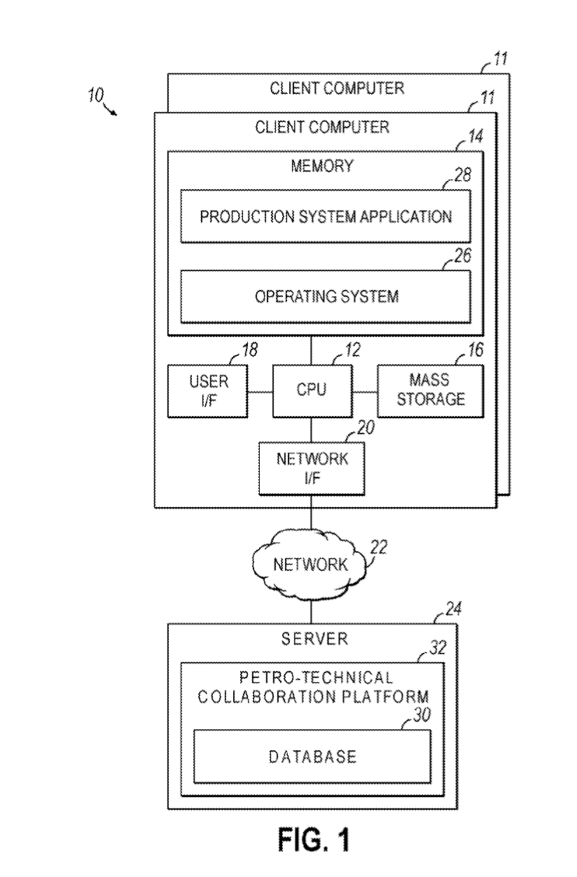

Turning now to the drawings, wherein like numbers denote like parts throughout the several views, FIG. 1 illustrates an example data processing system 10 in which the various technologies and techniques described herein may be implemented. System 10 is illustrated as including one or more computers 11, e.g., client computers, each including a central processing unit 12 (which may also be referred to as a processor) including at least one hardware-based microprocessor coupled to a memory 14, which may represent the random access memory (RAM) devices comprising the main storage of a computer 11, as well as any supplemental levels of memory, e.g., cache memories, non-volatile or backup memories (e.g., programmable or flash memories), read-only memories, etc. In addition, memory 14 may be considered to include memory storage physically located elsewhere in a computer 11, e.g., any cache memory in a microprocessor, as well as any storage capacity used as a virtual memory, e.g., as stored on a mass storage device 16 or on another computer coupled to a computer 11.

Each computer 11 also generally receives a number of inputs and outputs for communicating information externally. For interface with a user or operator, a computer 11 generally includes a user interface 18 incorporating one or more user input devices, e.g., a keyboard, a pointing device, a display, a printer, etc. Otherwise, user input may be received, e.g., over a network interface 20 coupled to a network 22, from one or more servers 24. A computer 11 also may be in communication with one or more mass storage devices 16, which may be, for example, internal hard disk storage devices, external hard disk storage devices, storage area network devices, etc.

A computer 11 generally operates under the control of an operating system 26 and executes or otherwise relies upon various computer software applications, components, programs, objects, modules, data structures, etc. For example, a production system application 28 may be used to access a database 30 of production equipment data supported in a petro-technical collaboration platform 32. Collaboration platform 32 or database 30 may be implemented using multiple servers 24 in some implementations, and it will be appreciated that each server 24 may incorporate processors, memory, and other hardware components similar to a client computer 11. In addition, other petro-technical applications, e.g., reservoir simulators, production management applications, etc. may be supported or integrated with production system application 28. In some embodiments, a production system application may be resident in a stand-alone computer in which production system data is resident on the same computer as the application. In other embodiments, various client-server, web-based and other distributed architectures may be used, whereby the data or functionality of a production system application is distributed among multiple computers.

In one non-limiting embodiment, for example, production system application may be compatible with the PIPESIM® software platform and environment, which is a steady-state, multiphase flow simulator application used for the design and diagnostic analysis of oil and gas production systems, and which is available from Schlumberger Ltd, and its affiliates. It will be appreciated, however, that the techniques discussed herein may be utilized in connection with other production system applications, so the invention is not limited to the particular software platforms and environments discussed herein.

In general, the routines executed to implement the embodiments disclosed herein, whether implemented as part of an operating system or a specific application, component, program, object, module or sequence of instructions, or even a subset thereof, will be referred to herein as “computer program code,” or simply “program code.” Program code generally comprises one or more instructions that are resident at various times in various memory and storage devices in a computer, and that, when read and executed by one or more processors in a computer, cause that computer to execute steps or elements embodying desired functionality. Moreover, while embodiments have and hereinafter will be described in the context of fully functioning computers and computer systems, those skilled in the art will appreciate that the various embodiments are capable of being distributed as a program product in a variety of forms, and that the invention applies equally regardless of the particular type of computer readable media used to actually carry out the distribution.

Such computer readable media may include computer readable storage media and communication media. Computer readable storage media is non-transitory in nature, and may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, DVD, or other optical storage, magnetic cassettes, magnetic tape, magnetic disk storage or other magnetic storage devices, or any other medium that can be used to store the desired information and which can be accessed by a computer 11. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

Various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Furthermore, it will be appreciated by those of ordinary skill in the art having the benefit of the instant disclosure that the various operations described herein that may be performed by any program code, or performed in any routines, workflows, or the like, may be combined, split, reordered, omitted, or supplemented with other techniques known in the art, and therefore, the invention is not limited to the particular sequences of operations described herein.

Those skilled in the art will recognize that the example environment illustrated in FIG. 1 is not intended to limit the invention. Indeed, those skilled in the art will recognize that other alternative hardware or software environments may be used without departing from the scope of the invention. For example, while one CPU 12 is shown, the computer 11 may include more than one processor (whether as a separate integrated circuit or multiple cores of a single integrated circuit).

### Oilfield Operations

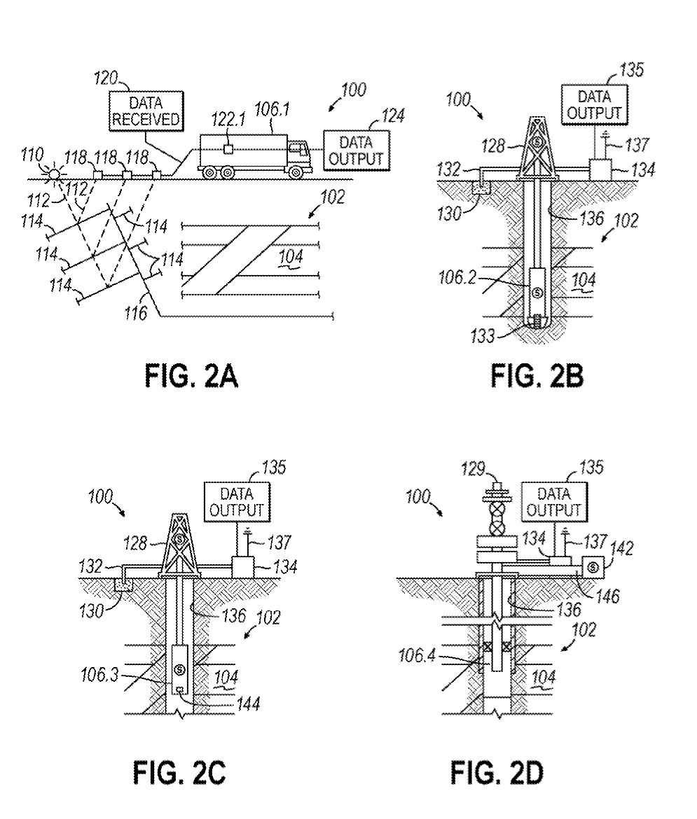

FIGS. 2A-2D illustrate simplified, schematic views of an oilfield 100 having subterranean formation 102 containing reservoir 104 therein in accordance with implementations of various technologies and techniques described herein. FIG. 2A illustrates a survey operation being performed by a survey tool, such as seismic truck 106.1, to measure properties of the subterranean formation. The survey operation is a seismic survey operation for producing sound vibrations. In FIG. 2A, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 2B illustrates a driving operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is generally filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools may be adapted for measuring downhole properties using logging while drilling tools. The logging while drilling tools may also be adapted for taking core sample 133 as shown.

Computer facilities may be positioned at various locations about the oilfield 100 (e.g., the surface unit 134) or at remote locations. Surface unit 134 may be used to communicate with the drilling tools or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools or at rig 128 to measure drilling parameters, such as weight on bit, torque on bit, pressures, temperatures, flow rates, compositions, rotary speed, or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan generally sets forth equipment, pressures, trajectories or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 or other data collection sources for analysis or other processing. The data collected by sensors (S) may be used alone or in combination with other data. The data may be collected in one or more databases or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, or manually by an operator. In some cases, well plans may be adjusted to select optimum operating conditions, or to avoid problems.

FIG. 2C illustrates a wireline operation being performed by wireline tool 106.3 suspended by rig 128 and into wellbore 136 of FIG. 2B. Wireline tool 106.3 is adapted for deployment into wellbore 136 for generating well logs, performing downhole tests or collecting samples. Wireline tool 106.3 may be used to provide another method and apparatus for performing a seismic survey operation. Wireline tool 106.3 may, for example, have an explosive, radioactive, electrical, or acoustic energy source 144 that sends or receives electrical signals to surrounding subterranean formations 102 and fluids therein.

Wireline tool 106.3 may be operatively connected to, for example, geophones 118 and a computer 122.1 of a seismic truck 106.1 of FIG. 2A. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition or other parameters of the field operation.

FIG. 20 illustrates a production operation being performed by production tool 106.4 deployed from a production unit or Christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, or the production facility, to measure fluid parameters, such as fluid composition, flow rates, pressures, temperatures, or other parameters of the production operation.

Production may also include injection wells for added recovery. One or more gathering facilities may be operatively connected to one or more of the wellsites for selectively collecting downhole fluids from the wellsite(s).

While FIGS. 2B-2D illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation or its geological formations may be used. Various sensors (S) may be located at various positions along the wellbore or the monitoring tools to collect or monitor the desired data. Other sources of data may also be provided from offsite locations.

The field configurations of FIGS. 2A-2D are intended to provide a brief description of an example of a field usable with oilfield application frameworks. Part, or all, of oilfield 100 may be on land, water, or sea. Also, while a single field measured at a single location is depicted, oilfield applications may be utilized with any combination of one or more oilfields, one or more processing facilities and one or more wellsites. The disclosed approach may be used in fields similar to those described in FIGS. 2A-2D; however, it is not limited to such fields.

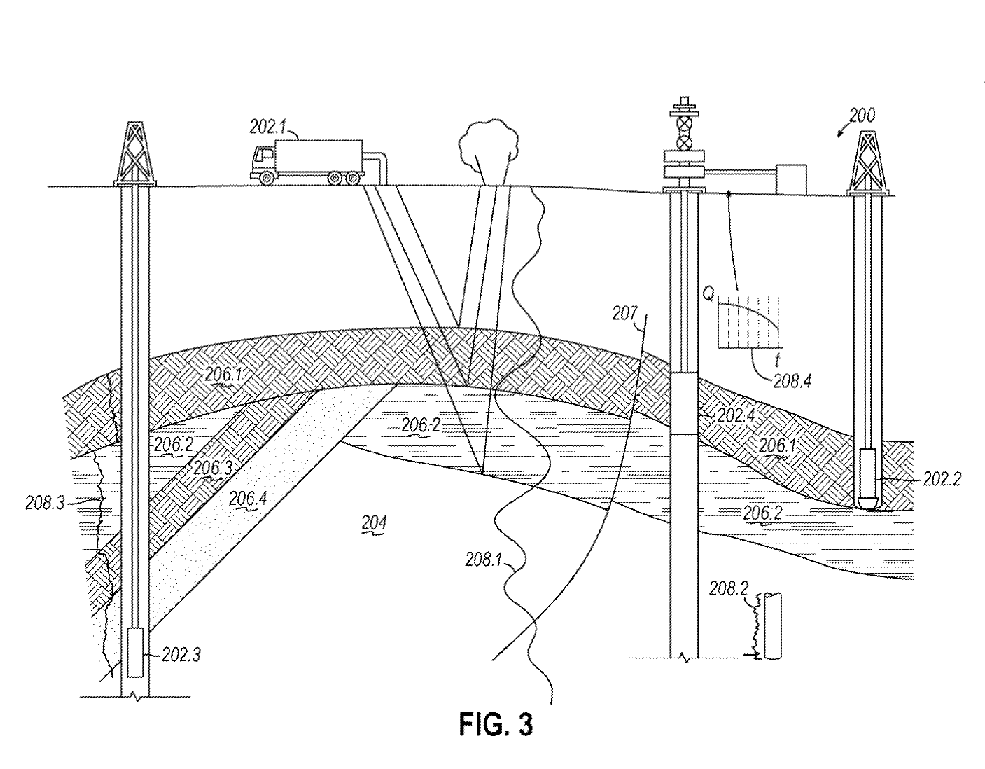

FIG. 3 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 2A-2D, respectively, or others not depicted. As shown, data acquisition tools 202.1-202A generate data plots or measurements 208.1-208.4, respectively. These data plots are depicted along oilfield 200 demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) or determine the accuracy of the measurements or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, or other measurement data and other parameters of interest. The static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures or formations, sometimes having extreme complexity. In some locations, generally below the water line, fluid may occupy pore spaces of the formations. Each of the measurement devices may be used to measure properties of the formations or its geological features. While each acquisition tool is shown as being in specific locations in oilfield 200, it will be appreciated that one or more types of measurement may be taken at one or more locations across one or more fields or other locations for comparison or analysis.

The data collected from various sources, such as the data acquisition tools of FIG. 3, may then be processed or evaluated. Generally, seismic data displayed in static data plot 208.1 from data acquisition tool 202.1 is used by a geophysicist to determine characteristics of the subterranean formations and features. The core data shown in static plot 208.2 or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling technique

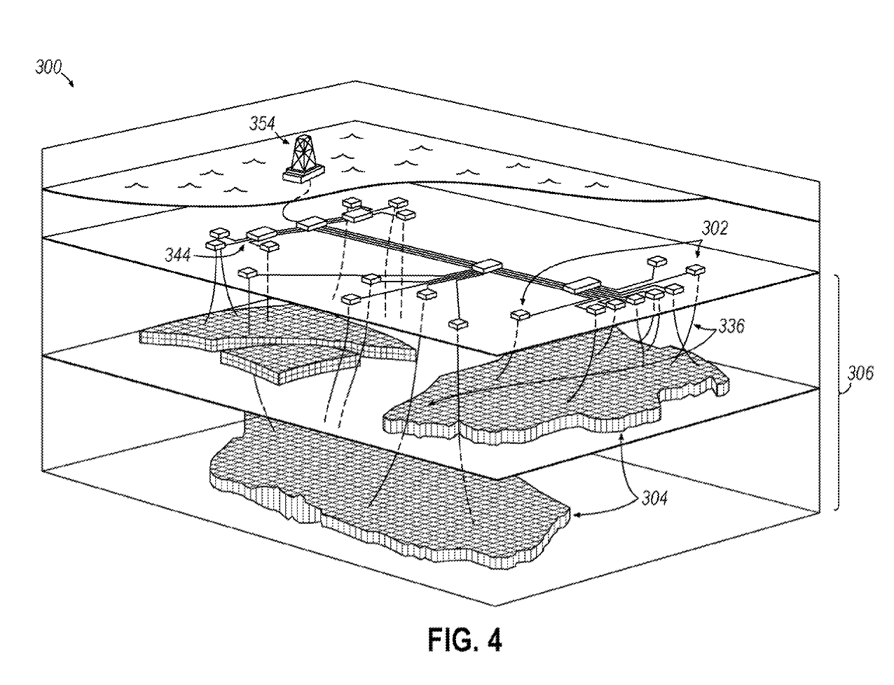

FIG. 4 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 4 is not intended to limit the scope of the oilfield application system. Part or all of the oilfield may be on land or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Dynamic Fluid Property Modeling

As discussed above, this disclosure generally relates to a dynamically updating graphical user interface that provides fluid properties corresponding to an oil and gas production system, where user input may cause the displays to be dynamically updated. In particular, the graphical user interface may include a production display that provides a simulated model corresponding to the oil and gas production system and a properties display that provides fluid properties associated with the oil and gas production system. In general, user input may select an object or fluid property parameter on a display of the graphical user interface, and the production display, properties display, or any other displays of an executing application may be synchronized based on the selection.

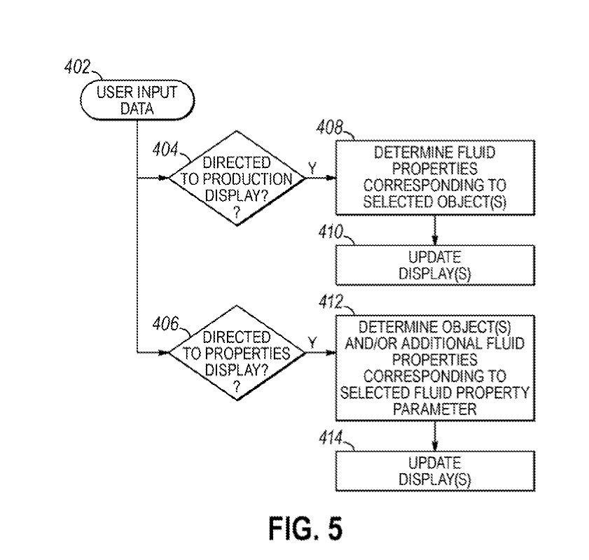

FIG. 5 provides a flowchart 400 that illustrates a sequence of operations that may be performed by a processor consistent with embodiments of the invention. In general, user input may be received (block 402), and the processor may determine whether the user input is directed to the production display (block 404) or the properties display (block 406). In response to the user input being directed to the production display (“Y” branch of block 404), the processor determines fluid properties corresponding to one or more objects selected by the user input (block 408), and the processor updates the properties display or the production display based on the determined fluid properties (block 410). In response to the user input being directed to the properties display (“Y” branch of block 406), the processor determines any objects corresponding to a fluid property parameter selected by the user input data or any additional fluid properties corresponding to the selected fluid property parameter (block 412), and the processor updates the production display or properties display based on the determined objects or additional fluid properties (block 414).

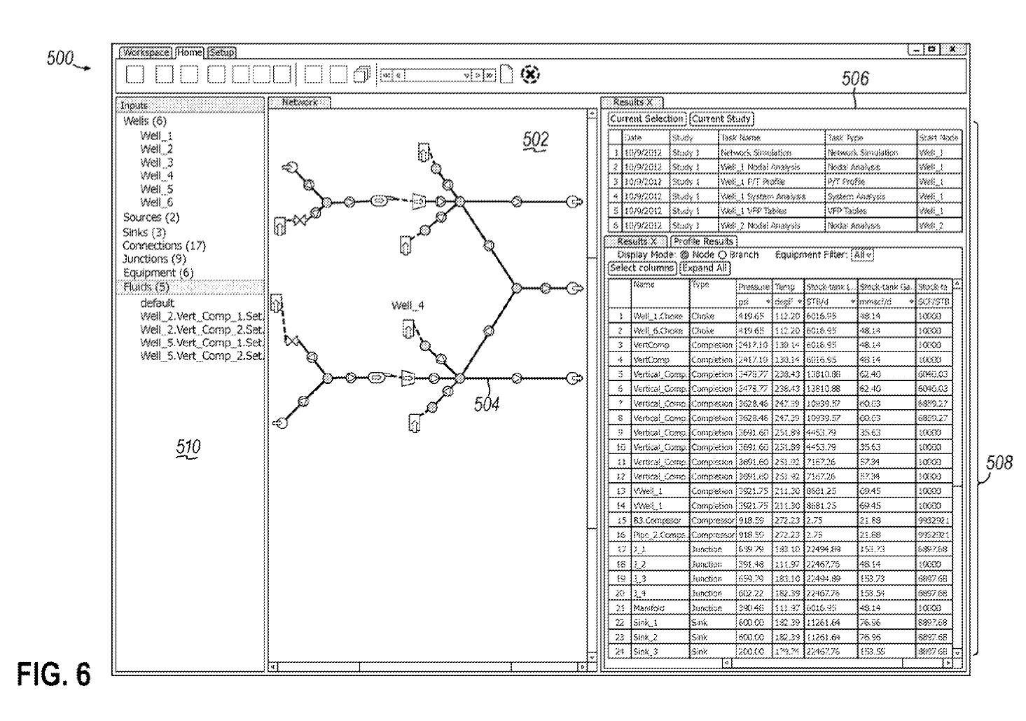

FIG. 6 provides a diagrammatic illustration of an example graphical user interface (GUI) 500 that may be output by a processor on a display. As shown, the GUI 500 includes a production display 502 that includes a simulated model 504 corresponding to an oil and gas production system. The graphical user interface also includes a fluid properties display 506 that includes fluid properties 508 associated with the oil and gas production system. In this example, the simulated model 504 is presented in GIS view, and the GUI 500 further includes a list display 510, that a user may interface with to select a particular object of the oil and gas production system or select a particular fluid.

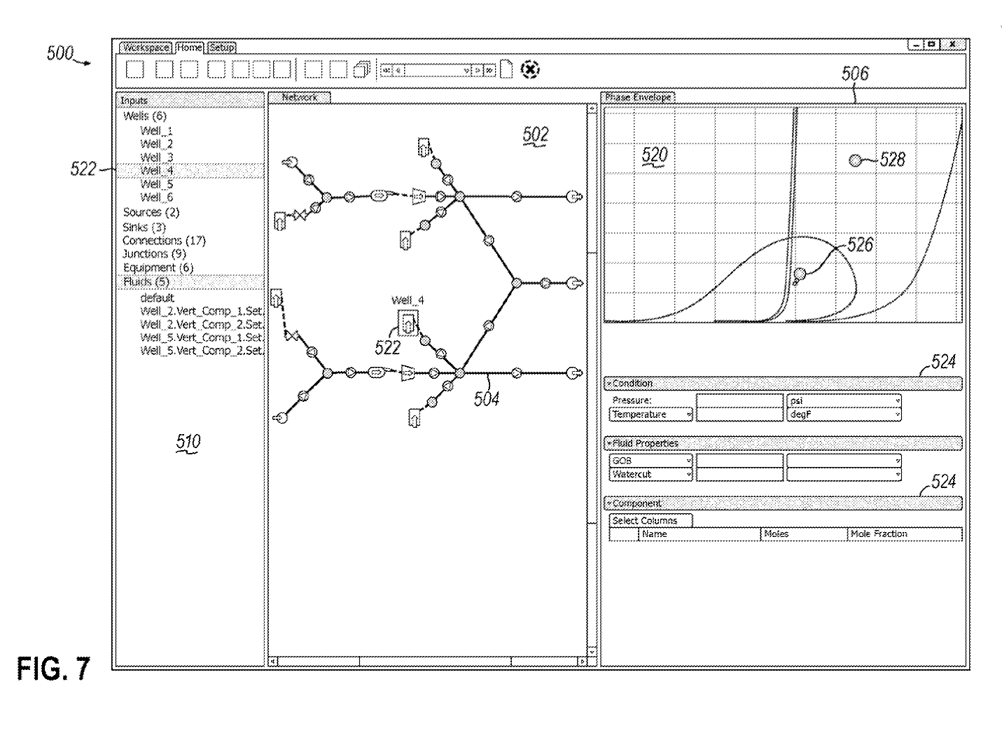

FIG. 7 provides a diagrammatic illustration of the example GUI 500 of FIG. 6, where the properties display 506 includes a phase envelope graph 520 for a fluid corresponding to a selected object 522 (in this example ‘Well_{—}4’). As shown in this example, the properties display 506 may further include input fields 524 where a user may provide input associated with fluid properties with which to update the GUI 500. In this example, the phase envelope graph 520 includes an indicator 526 that identifies the fluid conditions for the selected object 522. Furthermore, if a user provides input in the additional input fields 524, the properties display 506 may be updated to include an indicator 528 corresponding to the user input. In the example, the user input provided a non-standard reservoir temperature or pressure, and embodiments of the invention determined the corresponding fluid properties associated with the non-standard conditions and updated the properties display 506 to include the indicator 528 based thereon. The input fields 524 allow a user to consider the effects of various values for fluid property parameters for the selected object 522.

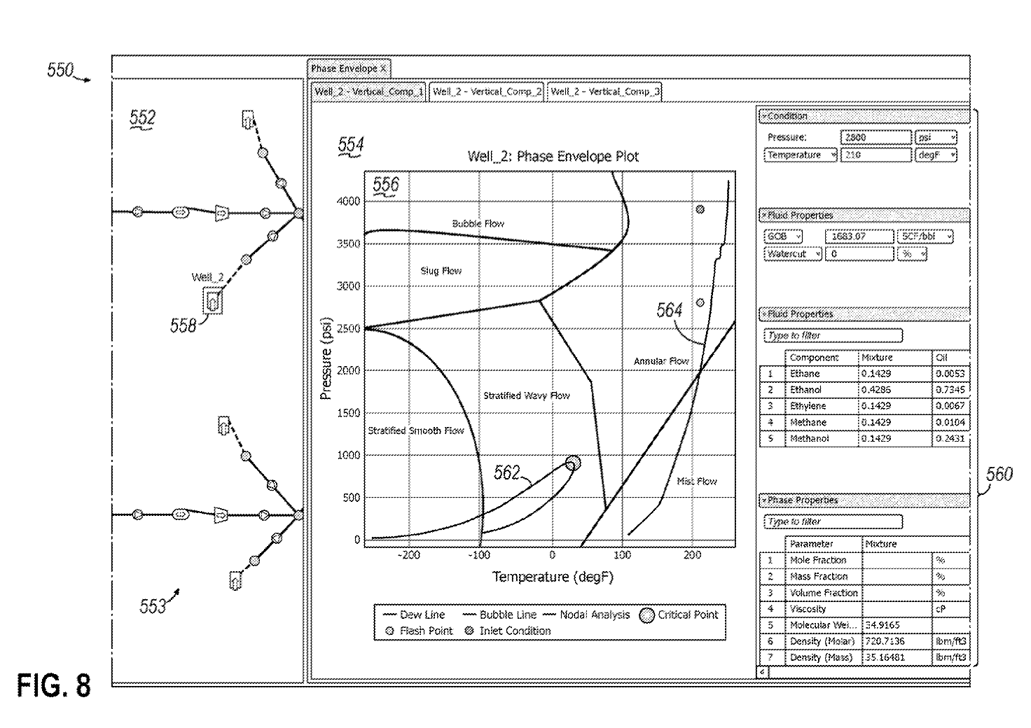

FIG. 8 provides a diagrammatic illustration of an example GUI 550 that may be output on a display by a processor consistent with embodiments of the invention. In this example, the GUI includes a production display 552 and properties display 554. The production display 552 includes a simulated model corresponding to an oil and gas production system 553, and the properties display 554 includes a phase envelope graph/plot 556 for a selected object 558 (in this example ‘Well_{—}2’) of the oil and gas production system and additional fluid properties 560 corresponding to the selected object 558. As shown, the phase envelope graph/plot 556 may include phase designations corresponding to the selected object 558 and the fluids associated with the selected object 558. The phase envelope graph 556 includes the phase envelope of the selected object 558, and a phase envelope 564 associated with a branch of the oil and gas production system that corresponds to the selected object 558. With reference to the properties display 554, in some embodiments of the invention, user input may select a region corresponding to a phase designation on the phase envelope, and the processor may determine whether any objects of the oil and gas production system correspond to the selected phase designation (i.e., operate within the temperature and pressure ranges of the phase designation). If any objects of the oil and gas production system are determined to correspond to the selected phase designation, the production display may be dynamically updated to identify the objects. For example, the processor may cause the GUI to highlight the determined objects. Other embodiments of the invention include similar dynamic updates based on user input directed to the production display or properties display.

Therefore, as illustrated by the examples, embodiments of the invention facilitate visualization and analysis of fluid and fluid properties at one or more objects of an oil and gas production system. In addition, consistent with embodiments of the invention, user input may change fluid property parameters for one or more objects to analyze/model the effect of such changes on the oil and gas production system. For example, fluid transport or flow at any object may be visualized for an oil and gas production system and fluid properties corresponding thereto may be dynamically updated and displayed in the graphical user interface, such dynamic updating and display may facilitate monitoring hydrate formation or flow issues in the oil and gas production system.

Implementation of the aforementioned functionality in a user interface would be well within the abilities of one of ordinary skill in the art having the benefit of the instant disclosure. In addition, while particular embodiments have been described, it is not intended that the invention be limited thereto, as it is intended that the invention be as broad in scope as the art will allow and that the specification be read likewise. It will therefore be appreciated by those skilled in the art that yet other modifications could be made without deviating from its spirit and scope as claimed.

In this description, the term “or” is used inclusively to indicate A or B or both. The term “may” is used to express possibility, such as possible embodiments. In the claims that follow, only those claims that state “means for” are to be interpreted as means-plus-function claims.

What is claimed is:

1. A method for dynamically modeling fluid behavior for an oil and gas production system, the method comprising:
receiving user input data directed to a graphical user interface that includes a production display including a simulated model representative of the oil and gas production system and a properties display including fluid properties corresponding to the oil and gas production system; and
in response to receiving user input data directed to the properties display that selects a fluid property parameter, updating, with at least one processor, the production display to correspond to the selected fluid property parameter.

2. The method of claim 1, further comprising:
in response to receiving user input data directed to the production display that selects an object of the simulated model, updating the properties display to include fluid properties associated with the selected object.

3. The method of claim 2, further comprising:
in response to receiving user input data directed to the production display that selects an object of the simulated model, calculating a fluid phase envelope plot for the selected object, wherein updating the display to include fluid properties associated with the selected object comprises updating the display to include the fluid phase envelope plot.

4. The method of claim 2, further comprising:
in response to receiving user input data directed to the production display that selects an object of the simulated model, dynamically determining a flash task calculation for a fluid at predefined operating conditions associated with the selected object.

5. The method of claim 1, wherein the properties display includes a phase envelope plot of a fluid associated with the oil and gas production system.

6. The method of claim 5, wherein the user input selects a fluid property parameter on the phase envelope plot, and wherein updating the production display includes updating the production display to identify at least one object of the oil and gas production system that corresponds to the fluid property parameter.

7. The method of claim 1, further comprising:
in response to receiving user input data directed to the properties display that selects a fluid property parameter, updating the properties display with additional fluid properties associated with the selected fluid property parameter.

8. The method of claim 1, further comprising:
analyzing objects of the oil and gas production system to identify at least one object corresponding to the selected fluid property parameter, wherein updating the production display to correspond to the selected fluid property parameter includes indicating the identified at least one object corresponding to the selected fluid property parameter in the simulated model of the production display.

9. The method of claim 1, wherein the properties display includes a fluid phase envelope plot, the selected fluid property parameter corresponds to a region of the fluid phase envelope, and the method further comprises:
analyzing objects of the oil and gas production system to identify each object that corresponds to the region of the fluid phase envelope, wherein updating the production display to correspond to the selected fluid property parameter comprises updating the production display to include an indication for each identified object.

10. A system comprising:
at least one processor; and
program code configured upon execution by the at least one processor to dynamically model fluid properties for an oil and gas production system by:
receiving user input data directed to a graphical user interface that includes a production display including a simulated model representative of the oil and gas production system and a properties display including fluid properties corresponding to the oil and gas production system; and
in response to receiving user input data directed to the properties display that selects a fluid property parameter, updating, with at least one processor, the production display to correspond to the selected fluid property parameter.

11. The system of claim 10, wherein the program code is further configured to, in response to receiving user input data directed to the production display that selects an object of the simulated model, update the properties display to include fluid properties associated with the selected object.

12. The system of claim 11, wherein the program code is further configured to, in response to receiving user input data directed to the production display that selects an object of the simulated model, calculate a fluid phase envelope plot for the selected object, wherein the program code is configured to update the display to include fluid properties associated with the selected object by updating the display to include the fluid phase envelope plot.

13. The system of claim 11, wherein the program code is further configured to, in response to receiving user input data directed to the production display that selects an object of the simulated model, dynamically determine a flash task calculation for a fluid at predefined operating conditions associated with the selected object.

14. The system of claim 10, wherein the properties display includes a phase envelope plot of a fluid associated with the oil and gas production system.

15. The system of claim 14, wherein the user input selects a fluid property parameter on the phase envelope plot, and wherein the program code is configured to update the production display by updating the production display to identify at least one object of the oil and gas production system that corresponds to the fluid property parameter.

16. The system of claim 10, wherein the program code is further configured to, in response to receiving user input data directed to the properties display that selects a fluid property parameter, update the properties display with additional fluid properties associated with the selected fluid property parameter.

17. The system of claim 10, wherein the program code is further configured to analyze objects of the oil and gas production system to identify at least one object corresponding to the selected fluid property parameter, and wherein the program code is configured to update the production display to correspond to the selected fluid property parameter by indicating the identified at least one object corresponding to the selected fluid property parameter in the simulated model of the production display.

18. The system of claim 10, wherein the properties display includes a fluid phase envelope plot and the selected fluid property parameter corresponds to a region of the fluid phase envelope, wherein the program code is further configured to analyze objects of the oil and gas production system to identify each object that corresponds to the region of the fluid phase envelope, and wherein the program code is configured to update the production display to correspond to the selected fluid property parameter by updating the production display to include an indication for each identified object.

19. A computer program product, comprising:
a computer readable medium; and
program code resident on the computer readable medium and configured upon execution by a processor to dynamically model fluid properties for an oil and gas production system by:
receiving user input data directed to a graphical user interface that includes a production display including a simulated model representative of the oil and gas production system and a properties display including fluid properties corresponding to the oil and gas production system; and
in response to receiving user input data directed to the properties display that selects a fluid property parameter, updating, with at least one processor, the production display to correspond to the selected fluid property parameter.
